(19) United States
(12) Patent Application Publication
(10) Pub. No.: US 2024/0114535 A1
(43) Pub. Date: Apr. 4, 2024

(54) SYSTEMS AND METHODS FOR SIDELINK OPERATION IN UNLICENSED SPECTRUM

(71) Applicant: Samsung Electronics Co., Ltd., Suwon-si (KR)

(72) Inventors: Yaser Mohamed Mostafa Kamal FOUAD, San Diego, CA (US); Philippe Jean Marc Michel SARTORI, Naperville, IL (US); Liang HU, San Diego, CA (US)

(21) Appl. No.: 18/464,168

(22) Filed: Sep. 8, 2023

Related U.S. Application Data
(60) Provisional application No. 63/412,238, filed on Sep. 30, 2022.

(51) Int. Cl. H04W 72/40; H04L 5/00; H04W 16/14; H04W 74/08

(52) U.S. Cl. CPC H04W 72/40; H04L 5/0055; H04W 16/14; H04W 74/0808

(57) ABSTRACT

A system and a method are disclosed for sidelink operations in unlicensed spectrum. In some embodiments, the method includes: receiving, by a first User Equipment (UE), a physical sidelink shared channel (PSSCH) transmission; refraining from sending an acknowledgment/negative acknowledgment (ACK/NACK) transmission, by the first UE, during a first Physical Sidelink Feedback Channel (PSFCH) occasion, wherein the refraining from sending occurs in response to an unsuccessful Listen Before Talk (LBT) attempt performed for the first PSFCH occasion; and sending an ACK/NACK transmission for the PSSCH transmission, during a second PSFCH occasion following the first PSFCH occasion.

### CROSS-REFERENCE TO RELATED APPLICATION

This application claims the priority benefit under 35 U.S.C. § 119(e) of U.S. Provisional Application No. 63/412,238, filed on Sep. 30, 2022, the disclosure of which is incorporated by reference in its entirety as if fully set forth herein.

### TECHNICAL FIELD

The disclosure generally relates to wireless communications. More particularly, the subject matter disclosed herein relates to improvements to systems and methods for sidelink operation in unlicensed spectrum.

### SUMMARY

Requirements on wireless systems continue to evolve as the number of user devices increases. For example, availability of the radio spectrum, through which many wireless devices communicate, becomes scarcer as more devices utilize its bandwidth. This is a constraint that, in some circumstances, limits wireless communications, for example, when a wireless device attempts to reserve a channel for communication and that channel is already occupied.

To solve this problem, additional radio bandwidth spectrums, such as the unlicensed spectrum, are utilized. Unlike the licensed spectrum, which is assigned exclusively to mobile network communications and thus is crowded with wireless signals, the unlicensed spectrum offers less crowded communication space with less regulatory constraints.

One issue with the use of the unlicensed spectrum is interference, which inhibits sidelink communications, often preventing them from exhibiting the same performance in the unlicensed spectrum than if the same methods are used in the licensed spectrum.

To overcome these issues, systems and methods are described herein for improved environmental adaptation when utilizing the unlicensed spectrum, including mitigating interference and the use of listen-before-talk (LBT) procedures.

According to an embodiment of the present disclosure, there is provided a method, including: receiving, by a first User Equipment (UE), a physical sidelink shared channel (PSSCH) transmission; refraining from sending an acknowledgment/negative acknowledgment (ACK/NACK) transmission, by the first UE, during a first Physical Sidelink Feedback Channel (PSFCH) occasion, wherein the refraining from sending occurs in response to an unsuccessful Listen Before Talk (LBT) attempt performed for the first PSFCH occasion; and sending an ACK/NACK transmission for the PSSCH transmission, during a second PSFCH occasion following the first PSFCH occasion.

In some embodiments, the method further includes: making, by the first UE, the Listen Before Talk (LBT) attempt for the first PSFCH occasion; and determining that the first LBT attempt was unsuccessful.

In some embodiments, the second PSFCH occasion is preconfigured by Radio Resource Control (RRC) signaling from a network node (gNB).

In some embodiments, the second PSFCH occasion is dynamically indicated.

In some embodiments, the second PSFCH occasion is dynamically indicated by a first stage Sidelink Control Information (SCI), a second stage SCI, or a Media Access Control Control Element (MAC CE).

In some embodiments, the method further includes: making, by the first UE, a successful Listen Before Talk (LBT) attempt; and determining, by the first UE, whether to make a first signal transmission, during a reservation interval, on the common interlace of the PSFCH.

In some embodiments, the first signal transmission is a Cyclic Prefix Extension (CPE) transmission.

In some embodiments, the method further includes: in response to the determining of whether to make a signal transmission during the reservation interval, refraining from making a signal transmission during the reservation interval.

In some embodiments, the determining of whether to make a signal transmission during the reservation interval includes determining whether to make a signal transmission during the reservation interval based on a UE identifier of the first UE.

In some embodiments, the determining of whether to make a signal transmission during the reservation interval includes determining whether to make a signal transmission during the reservation interval based on an indication received from a second UE.

In some embodiments, the method further includes: determining, by the first UE, as a result of a successful Listen Before Talk (LBT) attempt, a Channel Occupancy Time (COT); and sending a COT sharing indication to a second UE in a PSFCH symbol or by a DMRS sequence.

In some embodiments, the method further includes: transmitting, by the first UE, a PSFCH, in a plurality of physical resource blocks (PRBs) including a first PRB; determining that a frequency separation between the first PRB and a PRB of the common interlace of the PSFCH is less than a specified value; and refraining from transmitting on the PRB of the common interlace of the PSFCH.

According to an embodiment of the present disclosure, there is provided a User Equipment (UE), including: one or more processors; and a memory storing instructions which, when executed by the one or more processors, cause performance of: receiving a physical sidelink shared channel (PSSCH) transmission; refraining from sending of an acknowledgment/negative acknowledgment (ACK/NACK) transmission, during a first Physical Sidelink Feedback Channel (PSFCH) occasion, wherein the refraining from sending occurs in response to an unsuccessful Listen Before Talk (LBT) attempt performed for the first PSFCH occasion; and sending an ACK/NACK transmission for the PSSCH transmission, during a second PSFCH occasion following the first PSFCH occasion.

In some embodiments, the instructions, when executed by the one or more processors, further cause performance of: making a first Listen Before Talk (LBT) attempt for the first PSFCH occasion; and determining that the first LBT attempt was unsuccessful.

In some embodiments, the second PSFCH occasion is preconfigured by Radio Resource Control (RRC) signaling from a network node (gNB).

In some embodiments, the second PSFCH occasion is dynamically indicated.

In some embodiments, the second PSFCH occasion is dynamically indicated by a first stage Sidelink Control Information (SCI), a second stage SCI, or a Media Access Control Control Element (MAC CE).

In some embodiments, the instructions, when executed by the one or more processors, further cause performance of: making a successful Listen Before Talk (LBT) attempt; and determining whether to make a first signal transmission, during a reservation interval, on the common interlace of the PSFCH.

In some embodiments, the instructions, when executed by the one or more processors, further cause performance of: transmitting a PSFCH in a plurality of physical resource blocks (PRBs) including a first PRB; determining that a frequency separation between the first PRB and a PRB of the common interlace of the PSFCH is less than a specified value; and refraining from transmitting on the PRB of the common interlace of the PSFCH.

According to an embodiment of the present disclosure, there is provided a User Equipment, including: means for processing; and a memory storing instructions which, when executed by the means for processing, cause performance of: receiving a physical sidelink shared channel (PSSCH) transmission; refraining from sending of an acknowledgment/negative acknowledgment (ACK/NACK) transmission, during a first Physical Sidelink Feedback Channel (PSFCH) occasion, wherein the refraining from sending occurs in response to an unsuccessful Listen Before Talk (LBT) attempt performed for the first PSFCH occasion; and sending an ACK/NACK transmission for the PSSCH transmission, during a second PSFCH occasion following the first PSFCH occasion.

### BRIEF DESCRIPTION OF THE DRAWINGS

In the following section, the aspects of the subject matter disclosed herein will be described with reference to exemplary embodiments illustrated in the figures, in which:

FIG. 1A is a time-frequency resource diagram, according to an embodiment;

FIG. 1B is a time-frequency resource diagram, according to an embodiment;

FIG. 2 is a schematic drawing of User Equipments illustrating an example of a Power Spectral Density (PSD) limit violation, according to an embodiment;

FIG. 3 is an illustration of a situation in which a User Equipment is successful in acquiring the channel, according to an embodiment;

FIG. 4 is a schematic drawing of frequency multiplexed User Equipments, according to an embodiment;

FIG. 5 is a schematic drawing of a Road-Side Unit transmitting in the common interlace, according to an embodiment;

FIG. 6 is a time-frequency resource diagram, according to an embodiment;

FIG. 7 illustrates an NR sidelink slot with fast COT sharing indication, according to an embodiment;

FIG. 8 illustrates contention window size adjustments, according to an embodiment;

FIG. 9 illustrates resource selection, according to an embodiment;

FIG. 10 illustrates resource selection, according to an embodiment;

FIG. 11 illustrates a Transport Block transmission, according to an embodiment;

FIG. 12A is a flow chart of a method, according to an embodiment;

FIG. 12B is a flow chart of a method, according to an embodiment; and

FIG. 13 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. As used herein, the term “or” should be interpreted as “and/or”, such that, for example, “A or B” means any one of “A” or “B” or “A and B”.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

High data rate communication is a key enabler for future sidelink applications. Examples of such applications include autonomous driving and remote driving in which high throughput and high reliability transmissions are expected. To achieve this goal, it may be arranged for NR UEs to be able to transmit over a large spectrum. In other words, the spectrum available for sidelink transmissions represents an upper bound on the maximum throughput that the system can achieve.

Despite having more spectrum through the unlicensed spectrum, the NR User Equipments (UEs) may still need to coexist and contend for resources with other NR UEs as well as other systems that are operating in the unlicensed spectrum, such as WiFi systems. In addition, unlike the licensed band, sidelink UEs are required to abide with extra regulations when operating in the unlicensed band. For instance, regulations necessitate that when a UE is performing a transmission in the unlicensed band, it is expected to perform an (LBT) procedure to avoid collisions with other systems' transmissions. This procedure is applied on top of the Mode 2 resource selection procedure to avoid collisions with other NR UEs transmitting in the unlicensed spectrum. Thus, this puts the NR UEs at a competitive disadvantage with respect to other systems when performing channel access since the UE performs two forms of sensing instead of one. In addition, NR UEs are also required to fill most of the channel bandwidth when performing a transmission in the unlicensed spectrum to meet the Occupied Channel Bandwidth (OCB) requirement; this imposes a constraint on the number of RBs that should be used by a UE when performing a transmission in the unlicensed spectrum (e.g., using a small number of RBs will violate the OCB requirement).

To address these drawbacks, several approaches to enable NR UEs to meet the OCB and LBT requirements, when transmitting their ACK/NACK feedback in the PSFCH channel, are disclosed. In addition, enhancements to further optimize the performance of the contention window size (CWS) adjustment mechanism to reduce the incurred latency are disclosed. Furthermore, techniques to enable the dynamic indication of Physical Sidelink Feedback Channel (PSFCH) resources, thus increasing the number of UEs that may be frequency multiplexed in the PSFCH are disclosed. Finally, enhancements to the Mode 2 resource selection procedure to facilitate resource selection while taking the channel occupancy time (COT) sharing concept into consideration are disclosed. The details of the procedures are discussed below.

Unlicensed spectrum may play a key role in enabling a wide spectrum of sidelink applications by providing the much-needed wider spectrum for transmissions. One of the major issues with sidelink unlicensed is that two types of sensing must be done: (i) the Mode 2 sensing of NR sidelink, and (ii) the LBT sensing of the unlicensed spectrum to meet regulatory requirements. This additional Mode 2 sensing puts NR UEs at a disadvantage when compared to other systems operating in the unlicensed spectrum. In addition, when transmitting in the unlicensed spectrum, NR UEs will also be required to transmit on larger bandwidth to meet the OCB requirement. This increase in the transmission bandwidth may impose constraints on the number of NR UEs that may be frequency multiplexed at any given slot. To address this, techniques to enhance the ability of NR UEs to have a successful LBT before their intended future resource for transmission are disclosed. In particular, a technique to enable the PSFCH channel to meet the OCB requirement while still allowing frequency multiplexing by multiple UEs is disclosed. The enforced technique is efficient in the sense that it does not require all UEs to transmit in the full bandwidth and thus saves the limited power of these UEs. In addition, techniques to enable COT sharing between the transmitting (Tx) UE and the receiving (Rx) UE when sending the acknowledgement/negative acknowledgement (ACK/NACK) feedback over the PSFCH are disclosed. These techniques do not require the Rx UE to perform LBT before transmitting its ACK/NACK and thus increase its chances of acquiring the channel. Furthermore, some enhancements to the contention window size adjustments such that the contention window size is changed mostly due to the unlicensed channel occupancy (i.e., the impact of unfavorable channel conditions on the contention window size adjustment is reduced) are disclosed.

To enable PSFCH transmissions in unlicensed spectrum, signaling to allow NR UEs to dynamically allocate PSFCH resources for their transmission may be employed. In this case, UEs may either add additional PSFCH resources to increase their chances of having a successful LBT or they may use less PSFCH resources to allow the frequency multiplexing of additional UEs. Finally, changes to the Mode 2 resource selection procedure may be made such that the selected resources may be used for COT sharing without impacting the reservations done by neighboring UEs.

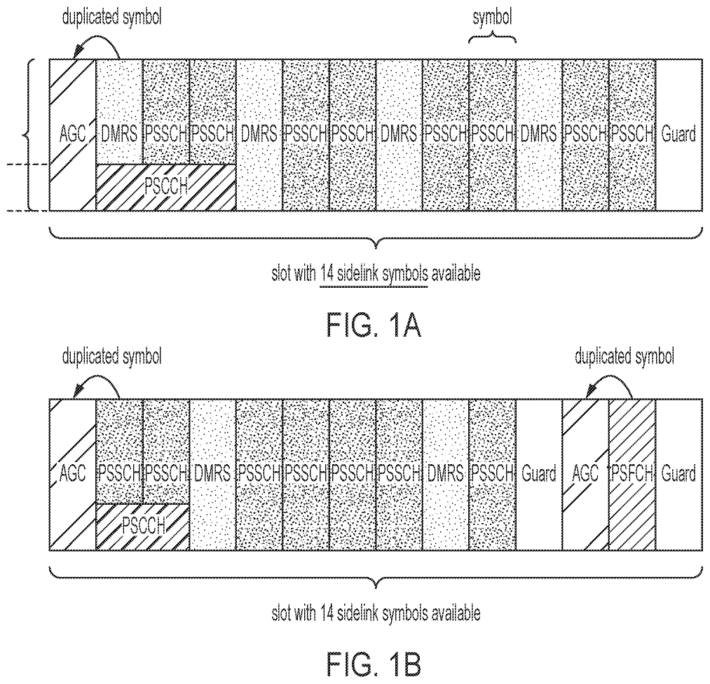

The Type 1 downlink (DL) channel access procedure for unlicensed spectrum is specified in 3GPP TS 37.213: “Physical layer procedures for shared spectrum channel access” (where 3GPP is the 3rd Generation Partnership Project). The NR Rel-16 sidelink slot format is illustrated in FIGS. 1A and 1B, which show the NR sidelink slot format with (FIG. 1A) and without (FIG. 1B) the physical sidelink feedback channel (PSFCH).

In Section D, signaling to allow NR UEs to dynamically allocate PSFCH resources for their transmission are disclosed. In this case, UEs may either add additional PSFCH resources to increase their chances of having a successful LBT or they may use less PSFCH resources to allow the frequency multiplexing of additional UEs. Finally, in Section E, changes to the Mode 2 resource selection procedure such that the selected resources may be used for COT sharing without impacting the reservations done by neighboring UEs are disclosed.

### Section A: PSFCH Enhancements to Meet OCB Requirement

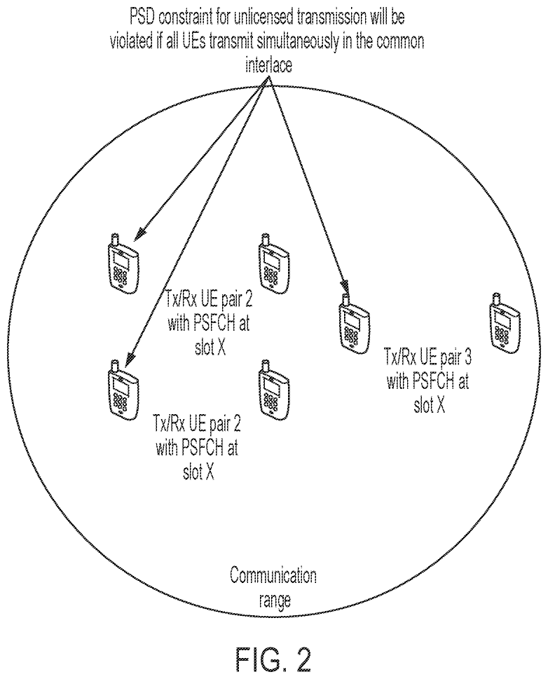

When transmitting in the unlicensed band, NR UEs are expected to meet the OCB requirement. In particular, they are required to fill the channel to a certain extent in each transmission. To achieve this goal, in 3GPP, it was agreed that NR UEs will be required to use a Physical Resource Block (PRB)-based interlace to fulfill the OCB requirement. In particular, unlike Rel-16/Rel-17 PSFCH in which an NR UE uses only one PRB to send its ACK/NACK feedback, the NR UE will be sending its feedback over multiple PRBs. To achieve this, one possibility is that the UEs perform two transmissions simultaneously. In particular, a UE may send a common interlace to fill the channel and at the same time use one or more PRBs to carry its feedback. However, this approach will require NR UEs to perform a transmission that does not carry any useful information to the Tx UE (i.e., the common interlace) thus resulting in a power loss and a possible impact the reliability of the actual ACK/NACK feedback since less power may be spent on transmitting the sequence carrying the feedback. In addition, it may also prevent UEs from performing frequency multiplexing in the frequency domain when transmitting their PSFCH because if too many UEs simultaneously transmit in the common interlace the combined PSD may be above the PSD limit for unlicensed operation, as shown in FIG. 2, which shows an example of a PSD limit violation due to multiple neighboring UEs simultaneously transmitting in common interlace.

To address these drawbacks, one possibility is to limit the transmission of the common interlace to only a subset of the UEs when the UEs are frequency multiplexed. For example, a UE may identify the presence of frequency multiplexing of PSFCH transmissions as follows:
(i) If LBT is performed before the PSFCH transmission, the presence of other UE's transmissions in the PSFCH may be detected by scanning for the reservation signal (e.g., the Cyclic Prefix Extension (CPE)).
(ii) If short control signaling exemption is allowed, an NR UE may identify the presence of transmissions of other UEs based on decoding the 1st and 2nd stage Sidelink Control Informations (SCIs) of the transmissions of neighboring UEs. In particular, if a time/frequency resource X is used to carry the data to a neighboring UE, then the UE may readily identify the corresponding PSFCH resource based on the selected resource X, the Tx UE identifier (ID), and the Rx UE ID.

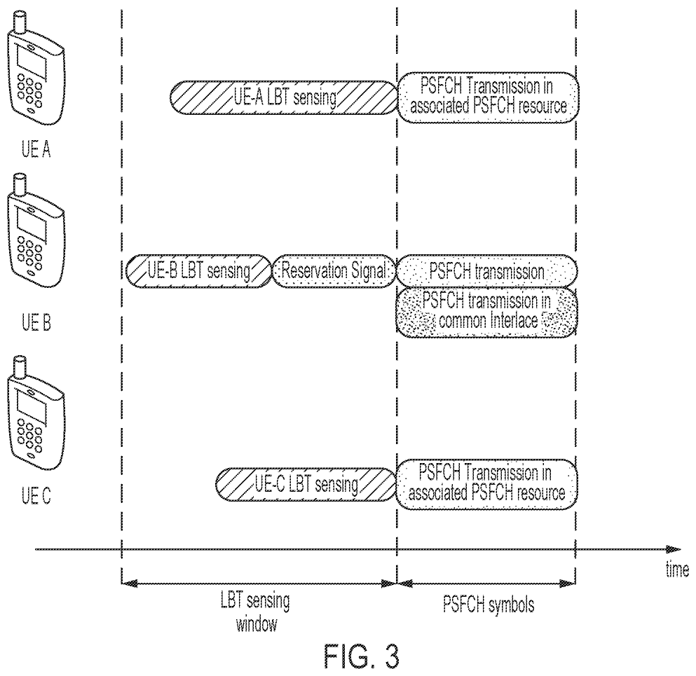

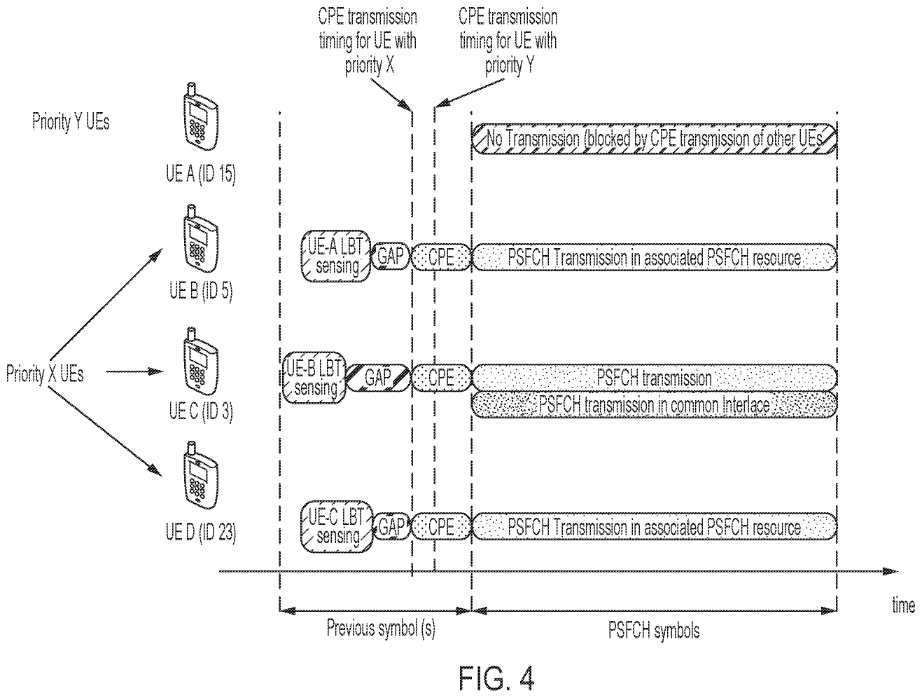

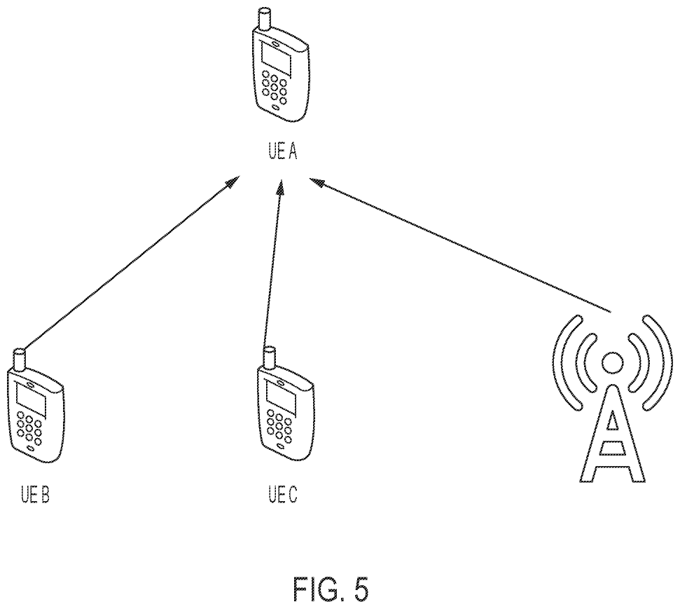

Once a UE identifies the presence of other NR UEs' transmissions, it may autonomously refrain from transmitting in the common interlace. This may be especially helpful in cases of unicast transmissions. This decision may be based on one or more of the following parameters:
(i) If LBT is performed before the PSFCH transmission, the first UE that was able to acquire the channel and send the reservation signal (e.g., the reservation signal needed to maintain the channel after LBT) will be the one sending in the common interlace as shown in FIG. 3, which shows a situation in which a UE that was successful in acquiring the channel sends its PSFCH in a dedicated PRB in addition to the common interlace. In this case, the assumption is that the reservation signal contains control information indicating that the reservation is performed by an NR UE. The decision to refrain from transmitting in the common interlace may also be based on the received signal strength being above a pre-configured threshold. In particular, if the received signal strength of the reservation signal is above a threshold, then the assumption is that the transmitting UE is nearby and thus there is no need for other UEs to retransmit again in the common interlace. However, if the received signal strength is below a pre-configured threshold, a retransmission in the common interlace may be necessary to perform the channel reservation and meet the OCB requirement. This retransmission will also help in resolving the hidden node problem since more power will be transmitted in the common interlace and thus the reservation signal will reach out to a longer range. Finally, it is observed that the threshold for retransmission in the common interlace may be configured per resource pool and may be dependent on priority. This is because higher priority UEs may need more protection and thus may have a larger threshold to increase the chances of retransmitting in the common interlace and accordingly help reduce the chances of having a hidden node problem. In this case a tradeoff may occur between the wasted power and reliability.
(ii) If LBT is performed before the PSFCH transmission and the LBT was successful, the UE may assume that all UEs with the same priority had a successful LBT. In particular, if the UEs perform the LBT sensing followed by a silence gap and finally a short reservation signal is sent (e.g., a CPE) before the actual transmission as shown in FIG. 4, then it is safe to assume that all UEs sharing the same priority will be able to transmit their PSFCH. In this case, a rule may be configured to dictate which UE will perform the transmission. For example, the UE with the lowest ID or the highest ID may be required to perform the transmission in the common interlace. Alternatively, the decision on whether to transmit in the common interlace may be based on the selected PSFCH resource. For example, the UE that transmitted in the lowest PRBs index or the highest PRB index may be the UE allowed to transmit in the common interlace. FIG. 4 illustrates that, when using a common starting point for reservation signal transmission based on priority, all UEs with same priority may be frequency multiplexed. Transmission in the common PSFCH interlace may be limited to the UE with the lowest ID in case of frequency multiplexing.
(iii) In cases in which short control signaling exemption is allowed, the transmission in the common interlace may be based on the ID of the UE that is expected to perform a transmission in the PSFCH and its priority. For example, transmission in the common interlace may be limited to UEs with the highest priority to ensure that the channel is properly occupied and to avoid the hidden node problem. The priority of the transmission may be identified based on the priority level indicated in the corresponding Physical Sidelink Control Channel (PSCCH) transmission that triggered the PSFCH transmission. In case of the presence of multiple UEs with the same priority, a rule may be configured to dictate which UE will perform the transmission. For example, the UE with the lowest ID or the highest ID may be required to perform the transmission in the common interlace.
(iv) The transmission in the common interlace may be done by a superior UE whenever a superior UE exists. For example, if there exists a Road Side Unit (RSU), it is expected that it has access to more power and thus it may always be the one responsible for transmitting in the common interlace if it exists as shown in FIG. 5. Its existence may be identified by its ID, for instance by dedicating a specific UE ID or by identifying its ID from the basic safety message if it is transmitted. The transmission by the superior UE may also be periodic in the sense that such a UE even if not involved in communication may still periodically perform the LBT, acquire the channel by sending a reservation signal and subsequently transmit in the common interlace. In addition, this transmission may be done with a different periodicity than that used by the PSFCH to reduce the overhead and the number of needed attempts to acquire the channel. This periodicity is pre-configured per resource pool and may be dependent on Channel Busy Ratio (CBR). In particular, the periodicity may be reduced if the CBR measured for NR UEs' transmissions is high since there is a high likelihood that an NR UE will be transmitting a PSFCH. On the other hand, the periodicity may be reduced if the channel is highly occupied to avoid the over occupation of the channel and the sending of a common interlace with no data. Here the high channel occupancy may be decided by multiple means including the measured CBR irrespective of NR UEs' transmissions or by counting the number of consecutive LBT successes or failures in a given duration. FIG. 5 shows an RSU transmitting in the common interlace to meet the OCB requirement.

Alternatively, a central decision may be made to identify the UE that will be transmitting in the common interlace. In particular, in case of groupcast Option 2, the NR UE performing the transmission may be selected by the Tx UE that sent the groupcast transmission. For example, the Tx UE may specify the UE with the member ID that is expected to transmit in the common interlace when the groupcast message is sent. This may be done either when initiating the groupcast and selecting the group member IDs wherein the Tx UE may associate the Tx UE with member ID X to perform the transmission in the common interlace. Alternatively, it may be done based on preconfigured rules in the sense that the UE with the highest or lowest member ID performs the transmission in the common interlace. This rule may be configured per resource pool. It may also be dependent on the UE location with respect to the Tx UE (i.e., the relative location to the Tx UE). This may be identified based either on the UEs' relative locations obtained from the basic safety messages or it may be based on the received signal strength in the corresponding PSCCH. In the latter case, a pre-configured threshold may be used by the UE to decide whether to transmit or not. In particular, two or more UEs may be assigned to transmit in the common interlace wherein one UE is expected to always transmit in the common interlace while the other UE or UEs transmit only in the common interlace if the received signal strength from the Tx UE is below a threshold or if its location is far from the Tx UE. This approach is specifically beneficial to overcome the hidden node problem.

In case of COT sharing between the Tx and Rx UEs, the selected UE that is expected to transmit in the common interlace may be indicated using the COT sharing parameters. In particular, a Tx UE may share the COT with multiple UEs to transmit in the PSFCH wherein the transmissions of these UEs are frequency multiplexed. However, in the COT sharing itself, the Tx UE may indicate the UE or UEs that are expected to transmit in the common interlace. For example, the first UE ID in the COT sharing parameters may be used to indicate the UE that will be transmitting in the common interlace. Alternatively, the UE with the lowest ID as indicated by the COT may be the one that will be transmitting in the common interlace.

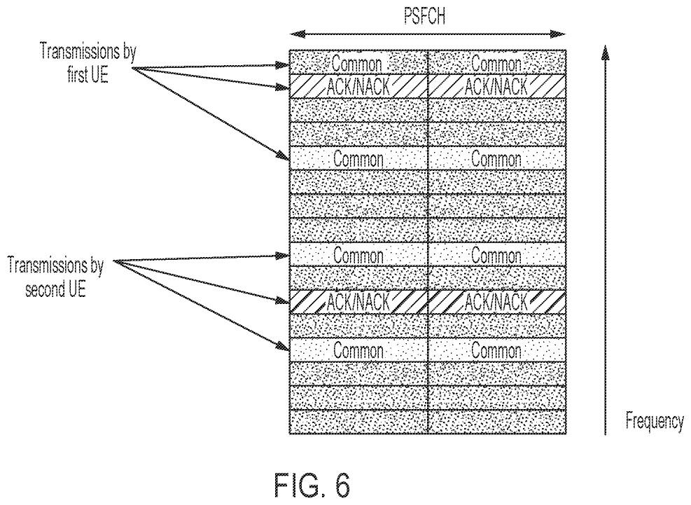

Another option is that the common interlace transmission may be divided across multiple UEs. This may help to reduce the transmission burden on the UE and to further resolve the hidden node problem. For example, if a common interlace that consists of 4 PRBs is needed to fulfil the OCB requirement, then if two UEs are present and transmitting in the PSFCH, then each UE may transmit in 2 PRBs as shown in FIG. 6. This may help in the following aspects:
(i) Reducing the power transmitted per UE since each UE is required to fill fewer RBs.
(ii) It may expand the transmission range of the common interlace and thus reduce the chances of having a hidden node. This is because the multiple UEs transmitting in the common interlace will generally not be present in the same location.

FIG. 6 shows an example in which the common interlace transmission to meet the OCB requirement is divided across multiple UEs.

The selected portion of the common interlace over which the UE transmits may be dependent on the resource that it will use for its PSFCH transmission. In particular, in case of two UEs being frequency multiplexed, the UE with the lowest RB index for its PSFCH transmission may end up transmitting in the half of the common interlace that has the lower RB index. On the other hand, the other UE with the higher RB index for its PSFCH transmission will end up transmitting in the other half of the common interlace. As mentioned above, a UE may identify the presence of PSFCH transmission by other UEs by detecting the PSCCH. Alternatively, in case of a groupcast Option 2, the Tx UE will be aware of the member UE IDs and may specify a subset of the interlace that will need to be filled by each of the Rx UEs. For instance, this may be done by assigning multiple member IDs to each UE. For example, a UE may be assigned (i) a member ID for its actual PSFCH transmission, carrying its ACK/NACK feedback, and (ii) another member ID to specify the RB(s) that it needs to fill from the common interlace.

In case of groupcast Option 1, if an NR UE detects a reservation signal with an indication of a presence of an NR UE, then it may skip the transmission on the common interlace since it may be done by the UE that was successful in acquiring the channel. Alternatively, the decision to skip the transmission on the common interlace may also be based on the received reservation signal strength being above a preconfigured threshold as discussed above.

Finally, it is disclosed how a UE may distribute its power between the common interlace and the ACK/NACK feedback. In particular, at a given slot, a UE may be required to send multiple PSFCH transmissions to one or more UEs. In addition, to meet the OCB requirement, it may also be required to perform non-data carrying transmission in the common interlace. In such a case, multiple options may be considered as follows.
(i) An NR UE may first prioritize the actual PSFCH transmissions carrying the ACK/NACK feedback and accordingly distribute the remaining available power to fill the common interlace. For example, if a UE can only perform 6 equal-powered PSFCH transmissions, and has a common interlace that spans 4 PRBs, and needs to provide 3 ACK/NACK feedback (by using 3 length-12 Zadoff-Chu (ZC) sequences spanning 3 RBs), then half the power may be dedicated to the ACK/NACK feedback and the remaining power may be divided equally among the PRBs within the common interlace.

An NR UE may skip the transmission of an RB within the interlace if there exists a scheduled PSFCH transmission nearby (e.g., within the same 1 MHz bandwidth). For example, if the size of the interlace is 4 PRBs, then the NR UE may divide the PSFCH resources into 4 quadrants. Subsequently, if there exists an actual PSFCH transmission carrying ACK/NACK information in a quadrant then the UE may skip the transmission of the common interlace on the PRB that falls within this quadrant. In some embodiments, a UE may transmit a PSFCH, in a plurality of physical resource blocks (PRBs) including a first PRB; the UE may determine that a frequency separation between the first PRB and a PRB of the common interlace of the PSFCH is less than a specified value (e.g., less than 1 MHz); and the UE may not transmit on the PRB of the common interlace of the PSFCH.

In various embodiments, if a common interlace is used to meet the OCB requirement, only a subset of the UEs may transmit in the common interlace.

In various embodiments, the presence of a neighboring UE that is transmitting in a common interlace may be identified based on the reservation signal after LBT or by relying on the received PSCCH reservation.

In various embodiments, the UE performing the transmission in the common interlace may be either the one that was first to acquire the channel after LBT sensing or based on its UE ID or the selected PSFCH resource.

In various embodiments, the UE performing the transmission in the common interlace may be selected based on the UE ID or the selected PSFCH resource (among a set of UEs that have the same priority level and that share the same CPE transmission starting point when short control exemption is not allowed).

In various embodiments, a UE may be required to perform a retransmission in the common interlace if the received signal strength of the reservation signal falls below a pre-configured threshold.

In various embodiments, the transmission in the common interlace may be done only by a super UE (e.g., an RSU or a gNB or a cluster head). This transmission may be periodic wherein the periodicity depends on the channel occupancy and measured CBR.

In various embodiments, in case of groupcast Option 2, the Tx UE may specify the UE that is expected to transmit in the common interlace (e.g., by a using a specific member ID).

In various embodiments, in case of COT sharing, the Tx UE may include in the COT sharing message an indication of the UE that is expected to transmit in the common interlace (e.g., by using the UE ID).

In various embodiments, the common interlace transmission may be shared by multiple UEs wherein the portion of the PRBs within the common interlace that are used by an NR UE may either by indicated by the Tx UE in case of groupcast option 2 or may be based on the detected PSCCHs.

In various embodiments, when a UE is required to perform a transmission in a common interlace along with its actual ACK/NACK feedback, it may prioritize the actual ACK/NACK feedback when selecting the Tx power.

In some embodiments, a UE may receive a physical sidelink shared channel (PSSCH) transmission; make a Listen Before Talk (LBT) attempt for the first PSFCH occasion; determine that the first LBT attempt was unsuccessful; refrain from sending an acknowledgment/negative acknowledgment (ACK/NACK) transmission, during a first Physical Sidelink Feedback Channel (PSFCH) occasion, wherein the refraining from sending occurs in response to the unsuccessful Listen Before Talk (LBT) attempt; and send an ACK/NACK transmission for the PSSCH transmission, during a second PSFCH occasion following the first PSFCH occasion. In some embodiments, a UE may make a successful Listen Before Talk (LBT) attempt; and determine whether to make a first signal transmission, during a reservation interval, on the common interlace of the PSFCH. The first signal transmission may be a reservation signal, and a goal of the determining may be to (i) make the first signal transmission if it will help the set of UEs meet the OCB requirement, and (ii) refrain from making the first signal transmission if doing so is not necessary for the set of UEs meet the OCB requirement.

### Section B: Enabling PSFCH Transmissions in a Shared COT

When transmitting in the unlicensed spectrum, NR UEs will need to perform LBT and accordingly compete with other systems for channel acquisition. This reduces their chances of having a successful transmission especially for Transport Blocks (TBs) with lower packet delay budget. However, a key aspect of NR transmissions is that they are relatively short (i.e., the longest slot duration is 1 ms for 15 kHz subcarrier spacing) if non-consecutive resource reservations are not allowed. Hence, given this short channel occupancy duration, much better performance may be achieved if a UE can share its COT with other UEs such that the other UEs are not required to perform LBT before accessing the channel. Unfortunately, this is not readily applicable for PSFCH transmissions due to the gap between the PSCCH and the corresponding PSFCH. In particular, if a Tx UE transmits to an Rx UE in a specific slot X, then it waits for a response and accordingly loses the COT because it is not expected to have an ACK/NACK response for one or more slots to allow enough time for the Rx UE to process the received TB and accordingly generate an ACK/NACK response. To address this drawback, the following aspects may be considered:

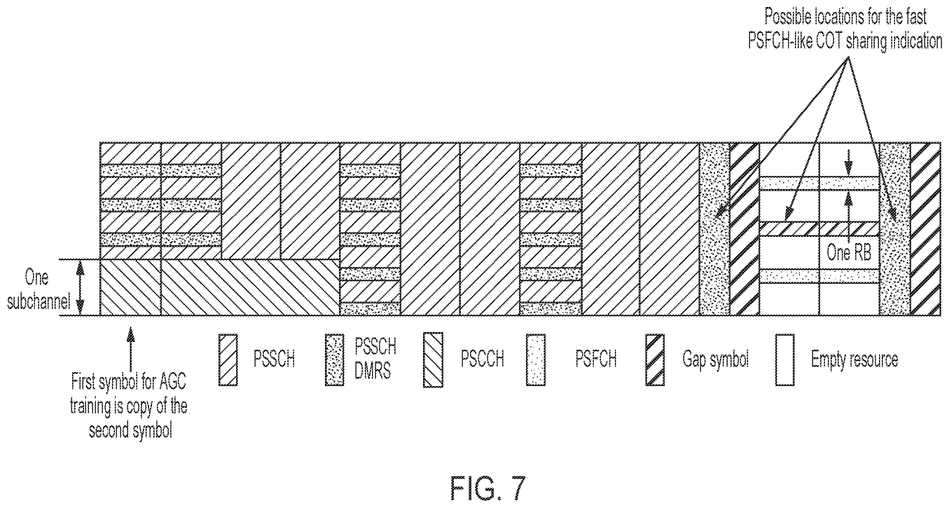

In case of non-consecutive slot transmissions, a fast COT sharing indication may be included either in the PSFCH symbol or the gap symbol before the PSFCH symbol if it exists as shown in FIG. 7. This may be done by using a specific RB and sending a specific sequence that indicates the presence of a COT sharing opportunity. In addition, the COT sharing indication may also be sent in the gap symbol at the end of the slot to enable fast processing. Another possibility for fast COT sharing indication may be based on DMRS signaling. In particular, a specific DMRS sequence may be reserved for COT sharing indication to the Rx UEs. Alternatively, a specific cover code may be applied on top of the Demodulation Reference Signal (DMRS) to indicate the COT sharing. Subsequently, once the Rx UE detects the COT sharing indication, it may perform a transmission to maintain the COT. In particular, once a fast COT sharing indication is provided, the Rx UE may do either of the following:
(i) If it does not have any TBs to transmit and the resources are not occupied by any neighboring UEs, then it may send a reservation signal to allow for processing of the received TB from the Tx UE followed by the actual ACK/NACK feedback.
(ii) If it has data to transmit and a resource reservation, it may perform the transmission followed by sending a reservation signal if necessary to maintain the channel until the TB is processed and an ACK/NACK may be transmitted.

If it has data to transmit but without a resource reservation, then it may perform an early in time transmission followed by sending a reservation signal if necessary to maintain the channel until the TB is processed and an ACK/NACK may be transmitted.

FIG. 7 illustrates an NR sidelink slot with fast COT sharing indication.

In various embodiments, in case of a slot with PSFCH, a fast COT sharing indication may be sent in either the PSFCH (e.g., by using a dedicated PSFCH resource) or in the gap symbol before the PSFCH.

In various embodiments, in case of a slot without PSFCH, the COT sharing indication may be sent in the gap symbol at the end of the slot.

In various embodiments, to reduce the processing burden and latency, the COT sharing indication may be sent using a PSFCH-like signal that is carried in a specific PRB.

In various embodiments, when an Rx UE receives a COT sharing indication sent by a Tx UE, it may either:
(i) Send a reservation signal to maintain the channel until the ACK/NACK feedback can be transmitted (i.e., the TB processing is done), or
(ii) Perform an early in time transmission if it has data to transmit followed by a reservation signal if necessary until the ACK/NACK feedback can be transmitted, or
(iii) Perform a scheduled TB transmission if it has data to transmit and there exists a reservation. This is then followed by a reservation signal if necessary until the ACK/NACK feedback can be transmitted.

### Section C: Distance-Based Contention Window Size Adjustments

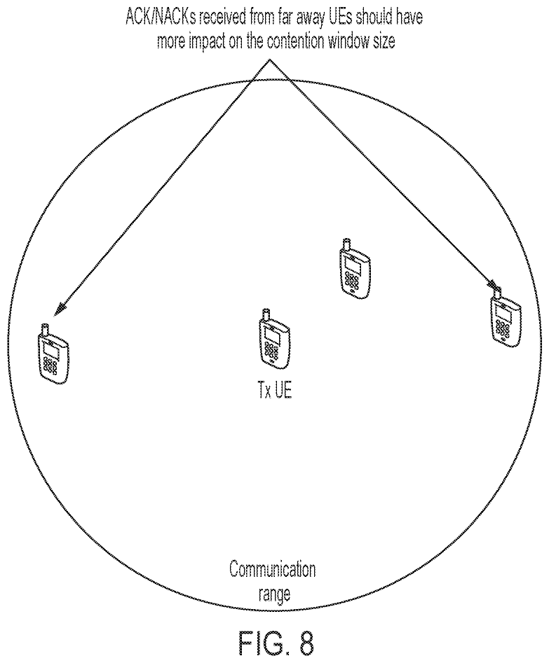

Before a NR UE can transmit in the unlicensed band, it is required to perform an LBT and is allowed to transmit only if the LBT was successful. Similar to NR Uu, the UE typically has a contention window size from which it randomly selects an LBT sensing duration and is only able to send if the channel is sensed to be free for a duration equal to the selected LBT sensing duration. In NR Uu, the contention window size adjustments are based on the number of received ACK/NACKs within a predefined duration. Despite the simplicity of this approach, the dynamics involved in sidelink transmission in which both the Tx and Rx UEs are mobile may require a more refined approach. In particular, the UEs locations (i.e., the relative distance between the Tx and Rx UEs) should be taken into consideration when performing contention window size adjustments. This is because the closer the Rx UE is to the Tx UE, the higher the likelihood of having a good channel condition, and thus getting a NACK will be mainly due to a missed transmission due to an LBT failure. On the other hand, the longer the distance between the Tx and Rx UEs, the higher the likelihood of having poor channel conditions and accordingly a NACK. Subsequently, since the contention window size should be adjusted based on channel occupancy of the unlicensed spectrum rather than on poor channel conditions, the distance between the Tx and Rx UEs should be taken into consideration when performing the contention window size adjustments, as shown in FIG. 8. FIG. 8 shows that ACK/NACK based contention window size adjustments for unlicensed sidelink transmission may take into consideration the distance between the Tx and Rx UEs.

In case of groupcast Option 1, the contention window size adjustments may be based on the range specified in the 2nd stage SCI. In particular, for longer ranges (i.e., ranges longer than a threshold that is configured per resource pool) indicated in the 2nd stage SCI, a larger percentage of NACKs may be required to increase the contention window size to its original value. In addition, the contention window size may be decreased faster (e.g., for a smaller number of ACKs within the predefined duration) to reduce the latency, because having a longer transmission range with no NACKs or a limited number of NACKs is a clear indication of a lower channel occupancy.

In case of unicast or groupcast Option 2, a similar approach may be considered in the sense that the contention window size is dependent on distance between the Tx UE and the Rx UE(s). In particular, the locations of the UEs sending the ACK/NACK feedback, if known, may also be taken into consideration. In this case, the UEs located far away (e.g., farther than a preconfigured threshold per resource pool) from the Tx UE are likely to experience failures due to channel conditions rather than interference from other systems and thus the number of NACKs received from these UEs should have less impact on increasing the contention window size. Similarly, the ACKs received from the UEs located far away from the Tx UEs should have more impact on reducing the contention window size because having a longer transmission range with no or limited number of NACKs is a clear indication of a lower channel occupancy.

In various embodiments, contention window size adjustments for sidelink unlicensed transmission should take into consideration the distance between the Tx and Rx UEs.

In various embodiments, in case of groupcast option 1, the changes of the contention window size may be dependent on the range indicated in the 2nd stage SCI. For larger ranges (e.g., above a pre-configured threshold) the contention window size may be reduced for a smaller number of ACKs in the predefined duration whereas a larger number of NACKs may be required to increase the contention window size.

In various embodiments, in case of groupcast option 2, the changes of the contention window size may be dependent on the location of the Rx UEs if known. In particular, the ACKs received from far-away UEs may have more impact on reducing the contention window size whereas the NACKs received from far away UEs may have less impact on increasing the contention window size.

### Section D: Dynamic Indication of PSFCH Resources

Before transmitting in the unlicensed band, an NR UE may be required to perform LBT to ensure that the channel is not occupied by any other device. If short control exemption is not supported, an Rx UE will be required to perform LBT before transmitting the ACK/NACK feedback to the Tx UE. Subsequently, there is no guarantee that the UE will be able to acquire the channel and accordingly transmits its ACK/NACK feedback thus resulting in a retransmission even if the TB was correctly received. To address this drawback, one possible approach is to allow the NR UE to have multiple PSFCH transmission occasions in the time domain such that if it failed to acquire the channel at one instance, it may still have one or more opportunities to transmit the ACK/NACK feedback. For example, an Rx UE may receive, from a Tx UE, a physical sidelink shared channel (PSSCH) transmission; the Rx UE may not send (e.g., because of an LBT failure) an acknowledgment/negative acknowledgment (ACK/NACK) transmission during a first physical sidelink feedback channel (PSFCH) occasion; and the Rx UE may send, during a second PSFCH occasion following the first PSFCH occasion, an ACK/NACK transmission for the PSSCH transmission.

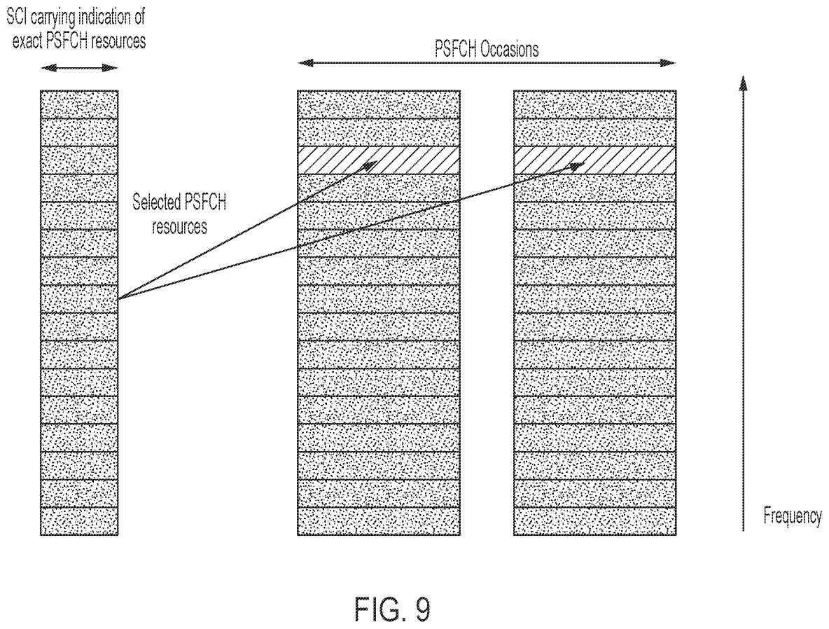

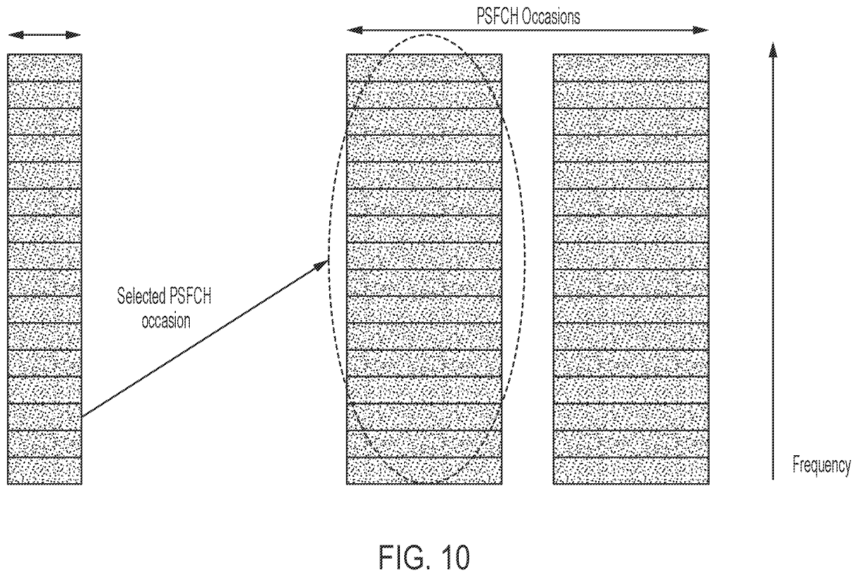

Despite the advantages of this approach, it may result in constraining the capacity of the PSFCH channel since each UE will need to be allocated multiple PSFCH occasions in the time domain. Hence, a more practical approach is to allow the dynamic allocation of PSFCH resources by NR UEs. In particular, an NR UE may use the 1st or 2nd stage SCI or a MAC CE to indicate the allocation of PSFCH resources in the time domain. In particular, a UE may indicate the utilization of 1 or more PSFCH occasions wherein the selected resource within this occasion may be indicated as:
(i) One or more exact resources that will be used to carry the ACK/NACK feedback. In other words, the dynamically indicated specific time/frequency/code resource can be used to carry the PSFCH feedback as shown in FIG. 9. FIG. 9 illustrates a situation in which the SCI carries an indication of the exact PSFCH resources that will be used to carry the ACK/NACK feedback.
(ii) One or more PSFCH occasions and the selection of the exact PSFCH resources that would carry the ACK/NACK feedback may be dependent on either the Tx UE ID, the Rx UE ID, the selected PSSCH resource, the total number of available PSFCH resources for dynamic indication, the member ID, or a combination thereof. In this case, the selected occasion may be indicated whereas the exact frequency/code PSFCH resource that will be used to carry the ACK/NACK feedback may be dependent on a pre-configured mapping function. The indication may be also mapped differently for different priority levels as discussed below. An example of this approach is shown in FIG. 10. FIG. 10 illustrates a situation in which the SCI carries only an indication of the exact PSFCH occasion that will be used to carry the ACK/NACK feedback.
(iii) An indication of the use of extra PSFCH resources for PSFCH feedback. In this case, the exact time/frequency/code resources that will be used to carry the ACK/NACK feedback will be selected based on a pre-configured mapping function and may be dependent on either the Tx UE ID, the Rx UE ID, the selected PSSCH resource, the total number of available PSFCH resources for dynamic indication, the member ID or a combination thereof. The indication may be also mapped differently for different priority levels as discussed below.

The exact fields that will be used to indicate the extra PSFCH resources may follow one of the following proposed solutions:
(i) A simple indication in which one extra bit is used to indicate the use of extra PSFCH resources. In this case, the mapping rule may be used to identify the exact time/frequency/code PSFCH resources carrying the ACK/NACK feedback. In addition, the number of extra PSFCH occasions may also be dependent on priority wherein a higher priority UE may have two extra PSFCH resources for transmission with the 1-bit indication whereas a low priority UE may have only one extra PSFCH resource with the 1-bit indication. In other words, the priority field already included in the SCI may be repurposed along with the extra 1-bit indication to indicate the number of extra PSFCH resources. This 1-bit indication may also be carried as a MAC CE field but such an embodiment may exhibit higher latency.
(ii) A new field similar to that of the Time Resource Indicator Value (TRIV) used for selecting the slots for up to 2 future transmissions (i.e., two extra PSFCH occasions) may be newly added to the SCI to indicate the exact extra PSFCH occasions that will be used to carry the ACK/NACK feedback. This TRIV may be much shorter than the one used for indicating the future resources since the feedback should not be too far away from the actual transmissions (i.e., much less than the 31-slot maximum gap between the first transmission and future reservations and the number of slots with PSFCH feedback within 31 slots may be much smaller). In addition, this new TRIV may be limited only to the unlicensed operation. The actual PSFCH resources that will be used to carry the ACK/NACK feedback may be dependent on either the Tx UE ID, the Rx UE ID, the selected PSSCH resource, the total number of available PSFCH resources for dynamic indication, the member ID or a combination thereof. This additional TRIV field may also be carried as a MAC CE field but such an embodiment may exhibit higher latency.
(iii) Two new fields similar to those of the TRIV and Frequency Resource Indicator Value (FRIV) used for selecting the exact resources for up to 2 future transmissions may be newly added to the SCI or as a MAC CE to indicate the exact extra PSFCH occasions that will be used to carry the ACK/NACK feedback. In this case, the TRIV field may be used to indicate the PSFCH occasions, whereas the FRIV field may be used to either:
(1) Indicate the exact PRB that will be used to carry the ACK/NACK feedback. However, a long FRIV field will be needed to cover all the possible PRBs. The selection of the exact sequences within the RB to carry the ACK/NACK feedback may be either pre-configured or it may follow mapping rules that take one or more parameters as an input (e.g., the Tx and Rx UE IDs)
(2) Indicate only the subchannel from which a PRB will be selected to carry the ACK/NACK feedback (i.e., a subset of PSFCH resources). In this case a short field will be needed since the number of subchannels will be limited. The selection of the exact PSFCH resource within the subset may be either pre-configured or may follow mapping rules that take one or more parameters as an input (e.g., the Tx and Rx UE IDs).

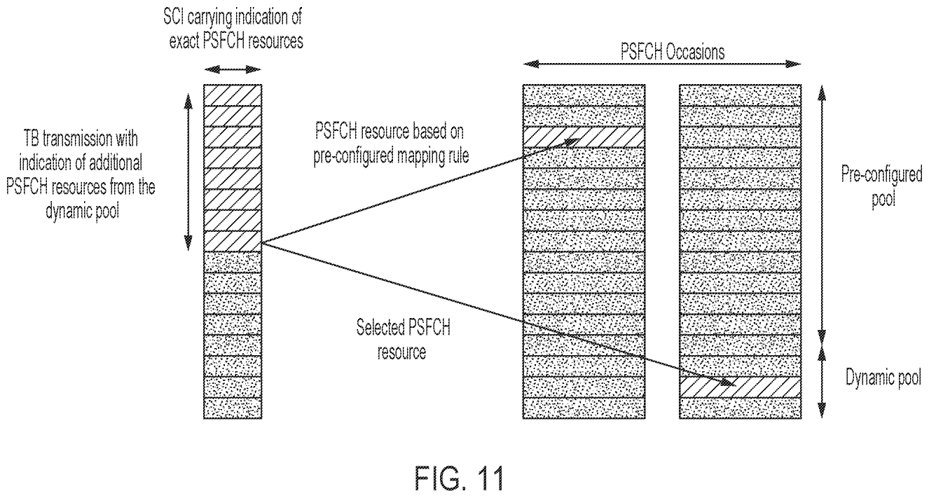

It may be useful to discuss the PSFCH resource pools from which the extra PSFCH resources may be indicated. In one approach, all the resources may be dynamically indicated by the Tx UE when performing its TB transmission. This approach may be helpful in case of COT sharing since having an earlier PSFCH transmission may not be helpful. However, this approach may not be efficient since all the PSFCH resources will need to be indicated and may not be correctly decoded thus resulting in collisions. Similarly, all the resources may be already pre-configured and a mapping rule may be used to specify the exact resources that will be used by the Rx UE. However, as discussed above, this approach may not be efficient and may introduce capacity constraints on the PSFCH channel. Hence, one approach is that the total PSFCH resources may be divided into two or more subsets wherein one or more subsets is pre-configured and there exists a defined mapping rule between a PSSCH resource and a PSFCH occasion while the other subsets may be indicated by one or more fields in the 1st or 2nd stage SCI or in a MAC CE. An example of this approach is captured in FIG. 11 in an example in which there exist only 2 subsets for simplicity. FIG. 11 shows a TB transmission with two PSFCH resources for ACK/NACK feedback (one from the pre-configured pool and another selected by field(s) in the SCI from the dynamic pool).

The distribution of the available PSFCH resources between the pre-configured and the dynamic pools may be based on pre-configuration and may be done on resource pool basis. In addition, the accessibility to the resources within the dynamic pool may be based on priority. In particular, only high priority UEs may be allowed to dynamically select resources from the dynamic pool to increase their chances of having a successful PSFCH transmission and accordingly meet their stringent latency requirements. Alternatively, the access to the resources within the dynamic resource pool may be dependent on the measured CBR. In particular, for high CBR values, the access to the dynamic pool of PSFCH resources may be restricted to high priority UEs. On the other hand, when the CBR is low and thus the chances of collisions are low, other UEs may also use the dynamic resource pool to increase their chances of having a successful ACK/NACK feedback. This may be done by pre-configuring multiple priority based CBR thresholds wherein the higher the priority of the UE, the higher its CBR threshold and accordingly it may be permitted to access the dynamic pool if its measured CBR is below the pre-configured threshold. Finally, it is observed that the UEs are transmitting in the unlicensed spectrum which may be shared with other non-NR UEs (e.g., WiFi devices). The measured CBR that is being considered to either allow or restrict the access to the dynamic resource pool may be either of the following:
(i) The CBR is measured only for NR UEs wherein only the slots that are occupied by one or more NR UEs are considered. In this case, the measured CBR is basically the ratio between the number of RBs that are occupied by NR UEs over the total number of RBs within the slots that are occupied by NR UEs.
(ii) The CBR is measured for the complete unlicensed channel irrespective of the device type that occupied the channel during the measurement. In this case, the CBR is basically the ratio between the number of RBs that are occupied by any device over the total number of RBs within a pre-defined duration.

Finally, it is observed that unlike NR Rel-16/Rel-17 UEs, the number of PSFCH resources in the dynamic resource pool may be limited, thus creating a higher likelihood of collisions between UEs. In other words, two UEs may end up selecting the exact same resource for PSFCH thus creating a false alarm case in which a UE receives an ACK/NACK from an unintended UE. This may happen when two UEs either select the exact same resource for PSFCH feedback or when they select the same PSFCH occasion and eventually their IDs are similar enough that they end up selecting the same resource. To address this problem, if the Rx UEs detect a false alarm case, they may respond to their corresponding Tx UEs by sending a NACK to trigger a retransmission.

In various embodiments, NR UEs may dynamically use additional PSFCH resources to combat LBT false alarms by sending a NACK to the corresponding Tx UE to trigger a retransmission.

In various embodiments, the indication of the use of additional PSFCH resources may be carried in the 1st or 2nd stage SCI or as a MAC CE.

In various embodiments, the dynamic selection of PSFCH resources for ACK/NACK feedback transmission may include either:
(i) A selection of the exact resources that will be used to carry the ACK/NACK feedback.
(ii) A selection of a specific PSFCH occasion from resources that will be selected to carry the ACK/NACK feedback.
(iii) An indication of using extra PSFCH feedback resources without specifying the exact resource that will be used to carry the ACK/NACK feedback.

In various embodiments, the following fields may be used to dynamically select additional PSFCH resources for ACK/NACK transmission:
(i) A one-bit field indicating the use of extra PSFCH resources.
(ii) A TRIV field indicating one or more PSFCH occasions within a given duration.
(iii) TRIV and FRIV fields indicating one or more PSFCH resources or a subset of resources within the given duration.

In various embodiments, when the SCI or MAC CE indication of extra PSFCH resources is mapped to a subset of resources, the selection of the exact PSFCH resources to carry the ACK/NACK feedback is based on either the Tx UE ID, the Rx UE ID, the selected PSSCH resource, the total number of available PSFCH resources for dynamic indication, the member ID, or a combination thereof.

In various embodiments, the available PSFCH resources may be divided into two or more subsets wherein some subset consists of resources that may be dynamically allocated whereas the resources in the other ones follow a pre-configured mapping rule for resource selection.

In various embodiments, the accessibility of the additional PSFCH resources in the dynamic pools may be based on measured CBR and/or the transmission priority. The measured CBR may be either measured for NR UEs only or for any device occupying the unlicensed spectrum.

In various embodiments, if a false alarm situation is detected due to two Tx UEs expecting their ACK/NACK feedback on the same resource, the corresponding Rx UEs may send a NACK on this resource to trigger a retransmission and avoid having a false alarm.

### Section E: Mode 2 Resource Selection Updates to Enable COT Sharing

Before transmitting in the unlicensed band, an NR UE may be required to perform LBT sensing. Hence, even if a UE performed a reservation at slot X, it is not certain that it will be able to transmit at that slot since it may fail at an LBT attempt in the slot. To address this problem, a COT sharing approach may be employed, in which a UE that had a successful LBT and was able to acquire the channel may share the channel with other UEs by sending a COT sharing indication. For example, a UE that made a successful LBT may maintain the channel for more than one slot but not need it and it may therefore share the channel with other neighboring UEs so that the neighboring UEs may avoid the need for a new LBT. A UE sharing the COT may be able to acquire the channel over multiple consecutive slots and thus it may ensure that no other NR UE has reservations over such slots. To enable the UE to accomplish this, the current Mode 2 resource selection procedure may be modified such that a UE attempts to select multi-slot resources (equivalent to the COT duration) rather than a single-slot resource. These multi-slot resources may be selected by the UE such that they result in either no collisions with other neighboring NR UEs or at least minimize the collisions with other neighboring UEs. In particular:
(i) The UE may consider multi-slot resources instead of single-slot resources Rxy.
(ii) The impact of neighboring UEs reservations on multi-slot reservations may be resolved. Some possibilities include:
   (1) An overlap in any slot within the multi-slot reservation may result in a discarding of the slot (subject to the measured Reference Signal Received Power (RSRP) and priority). However, the overlap with each slot within the multi-slot reservation may be treated separately. For example, in case of a two-slot reservation that overlaps with two other transmissions in the two slots, the two-slot reservation may be a candidate if each of its two slots are still considered as possible candidates after the measured RSRP levels are compared to the RSRP thresholds of each slot.
   (2) The number of candidate resources that need to be passed to the higher layer may be pre-configured separately for multi-slot reservations. This may help to prevent the NR UEs from including resources in the candidate resource set that would result in collisions.

Accordingly, a modified procedure for phase 1 of mode 2 sensing may be employed to resolve the issues described above. Modifications of the procedure relative to previously employed methods of phase 1, mode 2 sensing are indicated by annotations in square brackets. The modified procedure involves:
1) A candidate [multi-]slot resource for transmission R_{x,y} is defined as a set of L_{subCH} contiguous sub-channels [with sub-channel x+j in slots t_{y+z}^{SL} where j=0, . . . , L_{subCH}−1 and z=0, . . . , Nₛₗₒₜₛ−1, and Nₛₗₒₜₛ is the parameter provided by the higher layer that indicates the number of slots to be used for the PSSCH/PSCCH transmission.] The UE shall assume that any set of L_{subCH} contiguous sub-channels [and Nₛₗₒₜₛ contiguous slots] included in the corresponding resource pool within the time interval [n+T₁, n+T₂] correspond to [one candidate multi-slot] resource for UE performing full sensing, in a set of Y candidate slots within the time interval [n+T₁, n+T₂] for UE performing periodic-based partial sensing correspond to one candidate single-slot resource, or in a set of Y′ candidate slots within the time interval [n+T₁, n+T₂] for UE performing contiguous partial sensing if Prsvp_TX=0, correspond to one candidate single-slot resource, where
selection of T₁ is up to UE implementation under 0≤T₁≤T_{proc,1}^{SL}, where T_{proc,1}^{SL} is defined in slots in Table 8.1.4-2 where μ_{SL} is the SCS configuration of the SL BWP;
if T₂ₘᵢₙ is shorter than the remaining packet delay budget (in slots) then T₂ is up to UE implementation subject to T₂ₘᵢₙ≤T₂≤remaining packet delay budget (in slots); otherwise T₂ is set to the remaining packet delay budget (in slots).
Y is selected by UE where Y≥Yₘᵢₙ.
Y′ is selected by UE where Y′≥Y′ₘᵢₙ. When the UE performs contiguous partial sensing and if P_{rsvp_TX}=0, if the number of candidate single-slot resources Y′ is smaller than Y′ₘᵢₙ, it is up to UE implementation to include other candidate slots.

The total number of candidate single-slot resources is denoted by Mₜₒₜₐₗ. It will be appreciated that the new procedure for phase 1, mode two sensing utilizes multi-slot resource for the transmission R_{x,y}, and utilizes the parameter provided by the higher layer to indicate the number of slots to be sued for the PSSCH/PSCCH transmission. Furthermore, the UE assumes both that the set of L_{subCH} contiguous sub-channels and a new number Nₛₗₒₜₛ of contiguous slots is utilize in UE full sensing, improving upon contemporary methods of phase 1, mode 2 sensing.

For the sake of brevity, steps 2), 3), and 4) are omitted here and may be assumed to be performed according to contemporary methods of phase 1, mode 2 sensing. These steps correspond to the following. In step 2, the sensing window is identified in which the UE senses the reservations by its neighbors to be used for resource exclusion. In step 3 the UE identifies a set of RSRP thresholds based on which the UE decides whether a channel is occupied or not. In step 4, the UE creates the initial set of single-slot candidate resources from which the candidate resources will be selected after resource exclusion. The modified procedure then proceeds to step 5) below, wherein modifications are also shown in brackets.

A set S_{A} is initialized to the set of all the candidate [multi-]slot resources.
5) The UE shall exclude any candidate single-slot resource R_{x,y} from the set S_{A} if it meets all the following conditions:
   the UE has not monitored slot t′ₘ^{SL}, in Step 2.
   for any periodicity value allowed by the higher layer parameter sl-ResourceReservePeriodList and a hypothetical SCI format 1-A received in slot t′ₘ^{SL}, with ‘Resource reservation period’ field set to that periodicity value and indicating all subchannels of the resource pool [in the slots of the multi-slot resource,] condition c in step 6) would be met.
5a) If the number of candidate single-slot resources R_{x,y} remaining in the set S_{A} is smaller than [X_COT·]Mₜₒₜₐₗ, the set S_{A} is initialized to the set of all the candidate [multi-]slot resources as in step 4.
6) The UE shall exclude any candidate [multi-]slot resource R_{x,y} from the set S_{A} if it meets all the following conditions (which are summarized here for the sake of brevity):
Condition 1: The UE received an SCI from a neighboring UE indicating priority, periodicity and a resource reservation.
Condition 2: The measured signal strength is higher than a priority-based channel occupancy threshold.
Condition 3: One or more of the resources indicated by the SCI (including its periodic reserved resource) overlap with one or more of the PRBS of the candidate multi-slot Resource.
7) If the number of candidate single-slot resources remaining in the set S_{A} is smaller than [X_{COT}·]Mₜₒₜₐₗ, then Th(pᵢ, pⱼ) is increased by 3 dB for each priority value Th(pᵢ, pⱼ) and the procedure continues with step 4.

Phase 2: In NR Rel-16, the second phase of the Mode 2 resource selection procedure randomly selects one single-slot resources among the candidates provided by Phase 1 of the Mode 2 resource selection procedure. However, this procedure may be updated to obtain multi-slot reservations. In particular, the MAC layer may still randomly select a single-slot resource for the transmission. [However, the selected resource is discarded if the subsequent Nₛₗₒₜₛ following the one that carries the selected single-slot resource does not have the exact subchannels as unoccupied. For instance, if Nₛₗₒₜₛ=3 and the MAC layer randomly selected a single-candidate resource occupying slot X and subchannels 2 and 3, then this resource is not discarded only if slots X+1 and X+2 have subchannels 2 and 3 as unoccupied.]

The methods described herein may further include, or be further supplemented by modified procedures for phase 2, mode 2 sensing. Steps 1-4 below described the detailed change to phase 2 of the Mode 2 resource selection, but it will be appreciated that other steps, including additional unmodified steps to the overall phase 2, mode 2 selection, may precede or succeed the modified steps below
Step 1) Set Nₜᵣᵢₐₗₛ=1;
Step 2) Randomly select a resource R_{x,y} from the set of candidate single-slot resources in the set S_{A}.
Step 3) Identify the starting subchannel, the number of subchannels, the slot index of the selected UE and the value Nₛₗₒₜₛ.
Step 4) If resources R_{x(y+1)}, R_{x,(y+2)}, . . . , R_{x,(y+N}_{ₛₗₒₜₛ}₋₁₎ exist within the set S_{A} then maintain the selected resource R_{x,y}; otherwise set Nₜᵣᵢₐₗₛ=Nₜᵣᵢₐₗₛ+1 and if Nₜᵣᵢₐₗₛ≤N_{threshold} then go back to Step 1.

In various embodiments, for COT sharing to operate without triggering excessive resource reselections and pre-emptions, an updated Mode 2 resource selection procedure may be exploited by the Tx UE when selecting the resources for the COT.

In various embodiments, when performing resource selection, a Tx UE that intends to share a COT may either select a set of consecutive resources wherein the duration of these resources is equal to the shared COT duration or it may make an attempt to select multiple consecutive single-slot resources wherein the number of these single-slot resources is equal to the COT duration.

In various embodiments, when performing resource selection for a COT shared transmission, the set of candidate resources selected by phase 1 that needs to be passed to the MAC layer for resource selection may be pre-configured separately.

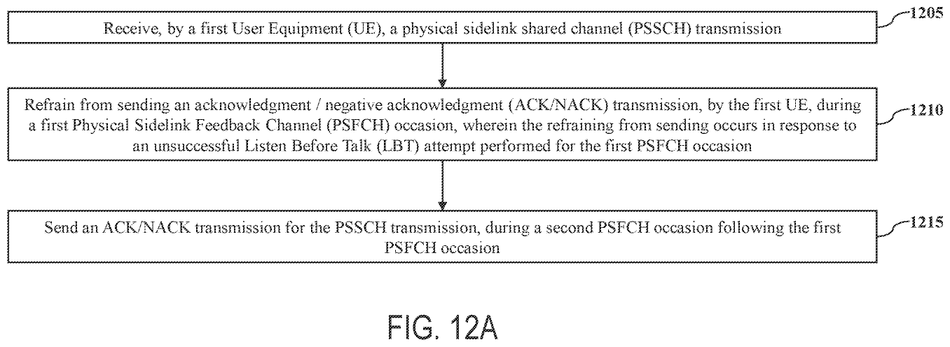

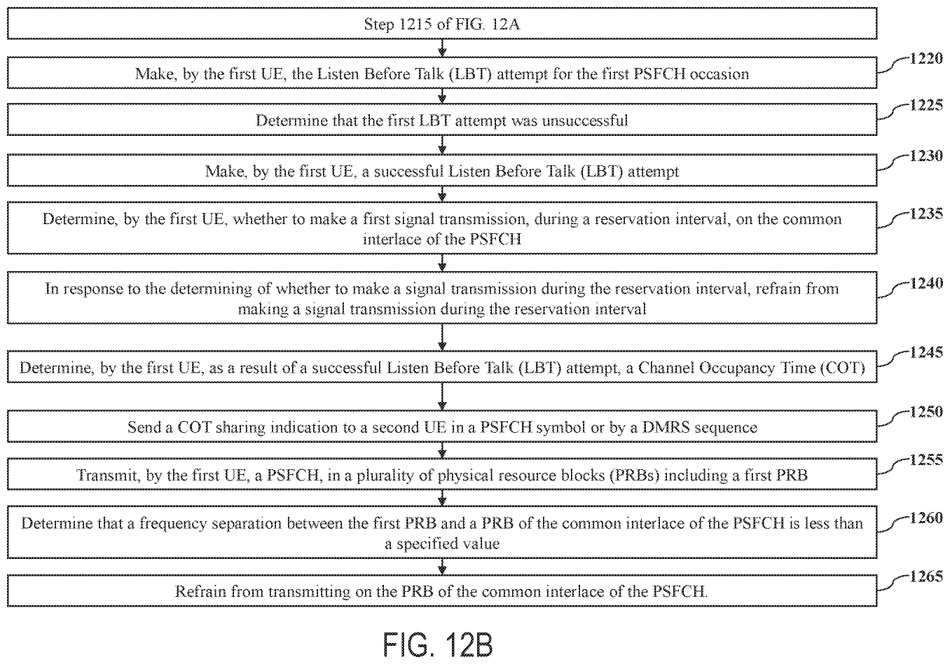

FIG. 12 is a flow chart of a method, in some embodiments. The method includes, receiving, at 1205, by a first User Equipment (UE), a physical sidelink shared channel (PSSCH) transmission; refraining, at 1210, from sending an acknowledgment/negative acknowledgment (ACK/NACK) transmission, by the first UE, during a first Physical Sidelink Feedback Channel (PSFCH) occasion, wherein the refraining from sending occurs in response to an unsuccessful Listen Before Talk (LBT) attempt performed for the first PSFCH occasion; and sending, at 1215 an ACK/NACK transmission for the PSSCH transmission, during a second PSFCH occasion following the first PSFCH occasion. Referring to FIG. 12B, the method may further include making, at 1220, by the first UE, the Listen Before Talk (LBT) attempt for the first PSFCH occasion; determining, at 1225, that the first LBT attempt was unsuccessful; making, at 1230, by the first UE, a successful Listen Before Talk (LBT) attempt; determining, at 1235, by the first UE, whether to make a first signal transmission, during a reservation interval, on the common interlace of the PSFCH; at 1240, in response to the determining of whether to make a signal transmission during the reservation interval, refraining from making a signal transmission during the reservation interval; determining, at 1245, by the first UE, as a result of a successful Listen Before Talk (LBT) attempt, a Channel Occupancy Time (COT); sending, at 1250, a COT sharing indication to a second UE in a PSFCH symbol or by a DMRS sequence; transmitting, at 1255, by the first UE, a PSFCH, in a plurality of physical resource blocks (PRBs) including a first PRB; determining, at 1260, that a frequency separation between the first PRB and a PRB of the common interlace of the PSFCH is less than a specified value; and refraining, at 1265, from transmitting on the PRB of the common interlace of the PSFCH.

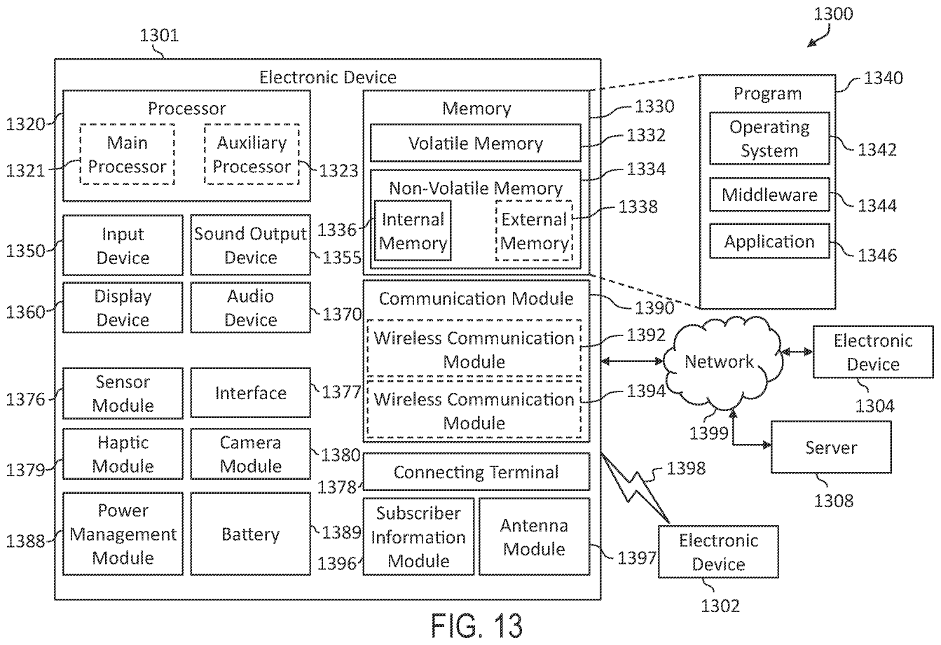

FIG. 13 is a block diagram of an electronic device 1301, such as a UE, in a network environment 1300, according to an embodiment. In some embodiments, the electronic device 1301 may perform some or all of the methods disclosed herein.

Referring to FIG. 13, an electronic device 1301 in a network environment 1300 may communicate with an electronic device 1302 via a first network 1398 (e.g., a short-range wireless communication network), or an electronic device 1304 or a server 1308 via a second network 1399 (e.g., a long-range wireless communication network). The electronic device 1301 may communicate with the electronic device 1304 via the server 1308. The electronic device 1301 may include a processor (or a means for processing) 1320, a memory 1330, an input device 1340, a sound output device 1355, a display device 1360, an audio module 1370, a sensor module 1376, an interface 1377, a haptic module 1379, a camera module 1380, a power management module 1388, a battery 1389, a communication module 1390, a subscriber identification module (SIM) card 1396, or an antenna module 1394. In one embodiment, at least one (e.g., the display device 1360 or the camera module 1380) of the components may be omitted from the electronic device 1301, or one or more other components may be added to the electronic device 1301. Some of the components may be implemented as a single integrated circuit (IC). For example, the sensor module 1376 (e.g., a fingerprint sensor, an iris sensor, or an illuminance sensor) may be embedded in the display device 1360 (e.g., a display).

The processor 1320 may execute software (e.g., a program 1340) to control at least one other component (e.g., a hardware or a software component) of the electronic device 1301 coupled with the processor 1320 and may perform various data processing or computations.

As at least part of the data processing or computations, the processor 1320 may load a command or data received from another component (e.g., the sensor module 1346 or the communication module 1390) in volatile memory 1332, process the command or the data stored in the volatile memory 1332, and store resulting data in non-volatile memory 1334. The processor 1320 may include a main processor 1321 (e.g., a central processing unit (CPU) or an application processor (AP)), and an auxiliary processor 1323 (e.g., a graphics processing unit (GPU), an image signal processor (ISP), a sensor hub processor, or a communication processor (CP)) that is operable independently from, or in conjunction with, the main processor 1321. Additionally or alternatively, the auxiliary processor 1323 may be adapted to consume less power than the main processor 1321, or execute a particular function. The auxiliary processor 1323 may be implemented as being separate from, or a part of, the main processor 1321.

The auxiliary processor 1323 may control at least some of the functions or states related to at least one component (e.g., the display device 1360, the sensor module 1376, or the communication module 1390) among the components of the electronic device 1301, instead of the main processor 1321 while the main processor 1321 is in an inactive (e.g., sleep) state, or together with the main processor 1321 while the main processor 1321 is in an active state (e.g., executing an application). The auxiliary processor 1323 (e.g., an image signal processor or a communication processor) may be implemented as part of another component (e.g., the camera module 1380 or the communication module 1390) functionally related to the auxiliary processor 1323.

The memory 1330 may store various data used by at least one component (e.g., the processor 1320 or the sensor module 1376) of the electronic device 1301. The various data may include, for example, software (e.g., the program 1340) and input data or output data for a command related thereto. The memory 1330 may include the volatile memory 1332 or the non-volatile memory 1334.

The program 1340 may be stored in the memory 1330 as software, and may include, for example, an operating system (OS) 1342, middleware 1344, or an application 1346.

The input device 1350 may receive a command or data to be used by another component (e.g., the processor 1320) of the electronic device 1301, from the outside (e.g., a user) of the electronic device 1301. The input device 1350 may include, for example, a microphone, a mouse, or a keyboard.

The sound output device 1355 may output sound signals to the outside of the electronic device 1301. The sound output device 1355 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1360 may visually provide information to the outside (e.g., a user) of the electronic device 1301. The display device 1360 may include, for example, a display, a hologram device, or a projector and control circuitry to control a corresponding one of the display, hologram device, and projector. The display device 1360 may include touch circuitry adapted to detect a touch, or sensor circuitry (e.g., a pressure sensor) adapted to measure the intensity of force incurred by the touch.

The audio module 1370 may convert a sound into an electrical signal and vice versa. The audio module 1370 may obtain the sound via the input device 1350 or output the sound via the sound output device 1355 or a headphone of an external electronic device 1302 directly (e.g., wired) or wirelessly coupled with the electronic device 1301.

The sensor module 1376 may detect an operational state (e.g., power or temperature) of the electronic device 1301 or an environmental state (e.g., a state of a user) external to the electronic device 1301, and then generate an electrical signal or data value corresponding to the detected state. The sensor module 1376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1377 may support one or more specified protocols to be used for the electronic device 1301 to be coupled with the external electronic device 1302 directly (e.g., wired) or wirelessly. The interface 1377 may include, for example, a high-definition multimedia interface (HDMI), a universal serial bus (USB) interface, a secure digital (SD) card interface, or an audio interface.

A connecting terminal 1378 may include a connector via which the electronic device 1301 may be physically connected with the external electronic device 1302. The connecting terminal 1378 may include, for example, an HDMI connector, a USB connector, an SD card connector, or an audio connector (e.g., a headphone connector).

The haptic module 1379 may convert an electrical signal into a mechanical stimulus (e.g., a vibration or a movement) or an electrical stimulus which may be recognized by a user via tactile sensation or kinesthetic sensation. The haptic module 1379 may include, for example, a motor, a piezoelectric element, or an electrical stimulator.

The camera module 1380 may capture a still image or moving images. The camera module 1380 may include one or more lenses, image sensors, image signal processors, or flashes. The power management module 1388 may manage power supplied to the electronic device 1301. The power management module 1388 may be implemented as at least part of, for example, a power management integrated circuit (PMIC).

The battery 1389 may supply power to at least one component of the electronic device 1301. The battery 1389 may include, for example, a primary cell which is not rechargeable, a secondary cell which is rechargeable, or a fuel cell.

The communication module 1390 may support establishing a direct (e.g., wired) communication channel or a wireless communication channel between the electronic device 1301 and the external electronic device (e.g., the electronic device 1302, the electronic device 1304, or the server 1308) and performing communication via the established communication channel. The communication module 1390 may include one or more communication processors that are operable independently from the processor 1320 (e.g., the AP) and supports a direct (e.g., wired) communication or a wireless communication. The communication module 1390 may include a wireless communication module 1392 (e.g., a cellular communication module, a short-range wireless communication module, or a global navigation satellite system (GNSS) communication module) or a wired communication module 1394 (e.g., a local area network (LAN) communication module or a power line communication (PLC) module). A corresponding one of these communication modules may communicate with the external electronic device via the first network 1398 (e.g., a short-range communication network, such as Bluetooth™, wireless-fidelity (Wi-Fi) direct, or a standard of the Infrared Data Association (IrDA)) or the second network 1399 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1392 may identify and authenticate the electronic device 1301 in a communication network, such as the first network 1398 or the second network 1399, using subscriber information (e.g., international mobile subscriber identity (IMSI)) stored in the subscriber identification module 1396.

The antenna module 1397 may transmit or receive a signal or power to or from the outside (e.g., the external electronic device) of the electronic device 1301. The antenna module 1397 may include one or more antennas, and, therefrom, at least one antenna appropriate for a communication scheme used in the communication network, such as the first network 1398 or the second network 1399, may be selected, for example, by the communication module 1390 (e.g., the wireless communication module 1392). The signal or the power may then be transmitted or received between the communication module 1390 and the external electronic device via the selected at least one antenna.

Commands or data may be transmitted or received between the electronic device 1301 and the external electronic device 1304 via the server 1308 coupled with the second network 1399. Each of the electronic devices 1302 and 1304 may be a device of a same type as, or a different type, from the electronic device 1301. All or some of operations to be executed at the electronic device 1301 may be executed at one or more of the external electronic devices 1302, 1304, or 1308. For example, if the electronic device 1301 should perform a function or a service automatically, or in response to a request from a user or another device, the electronic device 1301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1301. The electronic device 1301 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
receiving, by a first User Equipment (UE), a physical sidelink shared channel (PSSCH) transmission;
refraining from sending an acknowledgment/negative acknowledgment (ACK/NACK) transmission, by the first UE, during a first Physical Sidelink Feedback Channel (PSFCH) occasion, wherein the refraining from sending occurs in response to an unsuccessful Listen Before Talk (LBT) attempt performed for the first PSFCH occasion; and
sending an ACK/NACK transmission for the PSSCH transmission, during a second PSFCH occasion following the first PSFCH occasion.

2. The method of claim 1, further comprising:
making, by the first UE, the Listen Before Talk (LBT) attempt for the first PSFCH occasion; and
determining that the first LBT attempt was unsuccessful.

3. The method of claim 1, wherein the second PSFCH occasion is preconfigured by Radio Resource Control (RRC) signaling from a network node (gNB).

4. The method of claim 1, wherein the second PSFCH occasion is dynamically indicated.

5. The method of claim 4, wherein the second PSFCH occasion is dynamically indicated by a first stage Sidelink Control Information (SCI), a second stage SCI, or a Media Access Control Control Element (MAC CE).

6. The method of claim 1, further comprising:
making, by the first UE, a successful Listen Before Talk (LBT) attempt; and
determining, by the first UE, whether to make a first signal transmission, during a reservation interval, on the common interlace of the PSFCH.

7. The method of claim 6, wherein the first signal transmission is a Cyclic Prefix Extension (CPE) transmission.

8. The method of claim 6, further comprising:
in response to the determining of whether to make a signal transmission during the reservation interval, refraining from making a signal transmission during the reservation interval.

9. The method of claim 6, wherein the determining of whether to make a signal transmission during the reservation interval comprises determining whether to make a signal transmission during the reservation interval based on a UE identifier of the first UE.

10. The method of claim 6, wherein the determining of whether to make a signal transmission during the reservation interval comprises determining whether to make a signal transmission during the reservation interval based on an indication received from a second UE.

11. The method of claim 1, further comprising:
determining, by the first UE, as a result of a successful Listen Before Talk (LBT) attempt, a Channel Occupancy Time (COT); and
sending a COT sharing indication to a second UE in a PSFCH symbol or by a DMRS sequence.

12. The method of claim 1, further comprising:
transmitting, by the first UE, a PSFCH, in a plurality of physical resource blocks (PRBs) including a first PRB;
determining that a frequency separation between the first PRB and a PRB of the common interlace of the PSFCH is less than a specified value; and
refraining from transmitting on the PRB of the common interlace of the PSFCH.

13. A User Equipment (UE), comprising:
one or more processors; and
a memory storing instructions which, when executed by the one or more processors, cause performance of:
receiving a physical sidelink shared channel (PSSCH) transmission;
refraining from sending of an acknowledgment/negative acknowledgment (ACK/NACK) transmission, during a first Physical Sidelink Feedback Channel (PSFCH) occasion, wherein the refraining from sending occurs in response to an unsuccessful Listen Before Talk (LBT) attempt performed for the first PSFCH occasion; and
sending an ACK/NACK transmission for the PSSCH transmission, during a second PSFCH occasion following the first PSFCH occasion.

14. The UE of claim 13, wherein the instructions, when executed by the one or more processors, further cause performance of:
making a first Listen Before Talk (LBT) attempt for the first PSFCH occasion; and
determining that the first LBT attempt was unsuccessful.

15. The UE of claim 13, wherein the second PSFCH occasion is preconfigured by Radio Resource Control (RRC) signaling from a network node (gNB).

16. The UE of claim 15, wherein the second PSFCH occasion is dynamically indicated.

17. The UE of claim 16, wherein the second PSFCH occasion is dynamically indicated by a first stage Sidelink Control Information (SCI), a second stage SCI, or a Media Access Control Control Element (MAC CE).

18. The UE of claim 13, wherein the instructions, when executed by the one or more processors, further cause performance of:
making a successful Listen Before Talk (LBT) attempt; and
determining whether to make a first signal transmission, during a reservation interval, on the common interlace of the PSFCH.

19. The UE of claim 13, wherein the instructions, when executed by the one or more processors, further cause performance of:
transmitting a PSFCH in a plurality of physical resource blocks (PRBs) including a first PRB;
determining that a frequency separation between the first PRB and a PRB of the common interlace of the PSFCH is less than a specified value; and
refraining from transmitting on the PRB of the common interlace of the PSFCH.

20. A User Equipment, comprising:
means for processing; and
a memory storing instructions which, when executed by the means for processing, cause performance of:
receiving a physical sidelink shared channel (PSSCH) transmission;
refraining from sending of an acknowledgment/negative acknowledgment (ACK/NACK) transmission, during a first Physical Sidelink Feedback Channel (PSFCH) occasion, wherein the refraining from sending occurs in response to an unsuccessful Listen Before Talk (LBT) attempt performed for the first PSFCH occasion; and
sending an ACK/NACK transmission for the PSSCH transmission, during a second PSFCH occasion following the first PSFCH occasion.
